(19) United States
(12) Patent Application Publication
(10) Pub. No.: US 2020/0410031 A1
(43) Pub. Date: Dec. 31, 2020

(54) SYSTEMS AND METHODS FOR CLOUD COMPUTING

(71) Applicant: BEIJING DIDI INFINITY TECHNOLOGY AND DEVELOPMENT CO., LTD., Beijing (CN)

(72) Inventor: Hua CHEN, Beijing (CN)

(73) Assignee: BEIJING DIDI INFINITY TECHNOLOGY AND DEVELOPMENT CO., LTD., Beijing (CN)

(21) Appl. No.: 17/017,716

(22) Filed: Sep. 11, 2020

Related U.S. Application Data
(63) Continuation of application No. PCT/CN2019/078130, filed on Mar. 14, 2019.

(30) Foreign Application Priority Data
Mar. 14, 2018 (CN) 201810207498.7

(51) Int. Cl. G06F 16/955; G06F 16/958; G06F 9/54; G06F 16/951; H04L 29/08

(52) U.S. Cl. CPC G06F 16/9566; G06F 16/958; H04L 67/02; G06F 16/951; G06F 9/541

(57) ABSTRACT

The present disclosure is related to systems and methods for web crawling. The method includes responsive to receiving a request comprising one or more uniform resource locators (URLs), storing the one or more URLs in a seed database. The method also includes selecting at least one URL from the seed database based on a first count of tasks waiting to be executed. The method also includes generating a task based on each of the at least one selected URL. The method also includes dispatching the task to a corresponding crawler module to cause the crawler module to fetch at least one web page according to an URL associated with the task. The method also includes extracting element information of the at least one web page by parsing the at least one web page. The method further includes storing the element information in a file system.

### CROSS-REFERENCE TO RELATED APPLICATIONS

This application is a continuation of International Application No. PCT/CN2019/078130 field on Mar. 14, 2019, which claims priority to Chinese Patent Application No. 201810207498.7 filed on Mar. 14, 2018, the contents of each of which are hereby incorporated by reference.

### TECHNICAL FIELD

The present disclosure generally relates to network technology, and in particular, to systems and methods for cloud computing.

### BACKGROUND

Web crawling (also known as webpage data crawling or website crawling) refers to obtaining data from the web and/or converting the obtained unstructured data into structured data. The structured data may be efficiently stored in a local computer or a database for further data analysis.

Existing web crawling may have at least one of the following technical limitations:

(1) Using the existing web crawling, only webpage(s) may be fetched, or only a simple ability to fetch new links may be realized.

(2) Using the existing web crawling, only Hypertext Markup Language (HTML) webpage(s) may be fetched, and effective data of dynamic webpage(s) cannot be fetched.

(3) The existing web crawling may be non-distributed, and may be realized based on a single-machine or a simple homogeneous cluster, and accordingly, the efficiency of data obtaining and/or data parsing may be relatively low.

(4) Because of a lack of crawling pressure control for the crawling operation, it may be easy to be discovered and blocked by target website(s).

(5) For Internet Protocol (IP) address(es) provided by operator(s) in a domestic region (e.g., China), it may be easy to be blocked by the target website(s).

(6) It may be almost impossible to construct a platform based on crawling systems of different companies and/or different business lines, and thus, the cost of independent maintenance and/or development of the crawling systems may be extremely high.

Therefore, it is desirable to provide systems and methods for web crawling securely, efficiently, and cost-effectively.

### SUMMARY

According to an aspect of the present disclosure, a system for cloud computing may include an application program interface (API), a seed database, a job generator, and a crawler module. The application program interface (API) may be configured to provide a user interface to obtain a crawling job submitted by a user. The seed database, in communication with the API, may be configured to store one or more uniform resource locators (URLs) associated with the crawling job. The job generator, in communication with the seed database, may be configured to obtain the one or more URLs and to dispatch each of the one or more URLs to a corresponding crawler module. The crawler module, in communication with the job generator, is configured to fetch website data and/or webpage data based on the one or more URLs.

In some embodiments, the crawler module may include at least one of a spider crawler module or a chrome crawler module. The chrome crawler module may be configured to perform a JavaScript rendering operation on a rendered web page and/or a user-defined page prior to fetching the webpage data.

In some embodiments, the system may include a link discover module in communication with the crawler module and the seed database. The link discover module may be configured to determine a link crawl depth of the crawling job by parsing the website data and/or the webpage data fetched by the crawler module. The link discover module may be configured to update the crawling job based on the link crawl depth. The link discover module may be configured to feed back the updated crawling job to the seed database.

In some embodiments, the link discover module may include a first link generation logic module. The first link generation logic module may be configured to determine the link crawl depth of the crawling job by parsing, in real time, a first copy file of the website data and/or a second copy file of the webpage data fetched by the crawler module. The first link generation logic module may be configured to update the crawling job based on the link crawl depth. The first link generation logic module may be configured to feed back the updated crawling job to the seed database in real time.

In some embodiments, the system may include one or more distributed storage nodes in communication with the one or more crawler modules, configured to distributedly store element information associated with the fetched website data and/or the fetched webpage data according to a preset list.

In some embodiments, the link discover module may include a second link generation logic module in communication with the one or more distributed storage nodes. The second link generation logic module may be configured to determine, offline according to a predetermined schedule, one or more feature values corresponding to the element information stored in the one or more distributed storage nodes. The second link generation logic module may be configured to determine the link crawl depth based on the one or more feature values corresponding to the element information. The second link generation logic module may be configured to update the crawling job based on the link crawl depth. The second link generation logic module may be configured to feed back the updated crawling job to the seed database.

In some embodiments, the one or more feature values may include at least one of a frame parameter, an identification parameter, a label parameter, a type parameter, a text parameter, or an index parameter.

In some embodiments, the system may include a parsing module, in communication with the one or more distributed storage nodes. The parsing module may be configured to convert the element information into a specified format using one or more preset parsing algorithms. The parsing module may be configured to store the element information in the specified format in the one or more distributed storage nodes.

In some embodiments, the parsing module may be in communication with the API. The API may further be configured to obtain one or more parsing algorithms submitted by the user. The one or more submitted parsing algorithms may be designated as the one or more preset parsing algorithms stored in the parsing module.

In some embodiments, the system may include a proxy module in communication with the crawler module. The proxy module may be configured to collect and verify one or more proxies with hypertext transfer protocols (HTTPs). The proxy module may be configured to cooperate with the crawler module to fetch website data and/or webpage data based on the one or more URLs.

In some embodiments, the proxy module may further be configured to provide a crawling pressure control for the chrome crawler module.

In some embodiments, at least one URL that the chrome crawler module supports for crawling may include a user-defined logic algorithm.

In some embodiments, the system may include a crawling pressure control module in communication with the crawler module. The crawling pressure control module may be configured to control, according to a preset count of concurrent fetch requests and/or a preset crawling frequency, the crawler module to fetch website data and/or webpage data.

In some embodiments, the system for cloud computing may run on an operation and maintenance platform on a basis of platform-as-a-service (PAAS).

In some embodiments, the operation and maintenance platform may be configured to initiate a container for implementing the crawling job.

In some embodiments, the operation and maintenance platform may further be configured to manage the container dynamically.

In some embodiments, the system for cloud computing may be in communication with or includes a storage system configured to store a configuration file including configuration information relating to the crawling job.

According to another aspect of the present disclosure, a system for cloud computing may include at least one storage medium storing a set of instructions, and at least one processor in communication with the at least one storage medium. When executing the stored set of instructions, the at least one processor may cause the system to responsive to receive a request comprising one or more uniform resource locators (URLs), store the one or more URLs in a seed database. The at least one processor may cause the system to select at least one URL from the seed database based on a first count of tasks waiting to be executed. The at least one processor may cause the system to generate a task based on each of the at least one selected URL. The at least one processor may cause the system to dispatch the task to a corresponding crawler module to cause the crawler module to fetch at least one web page according to an URL associated with the task. The at least one processor may cause the system to extract element information of the at least one web page by parsing the at least one web page; and store the element information in a file system.

In some embodiments, the at least one processor may cause the system to receive, via an application program interface (API), the request for web crawling initiated by a user.

In some embodiments, the at least one processor may cause the system to identify the first count of tasks waiting to be executed. The at least one processor may cause the system to identify a second count of URLs in the seed database. The at least one processor may cause the system to determine whether to select an URL based on the first count or the second count. The at least one processor may cause the system to in response to a determination that at least one of the first count or the second count satisfies one or more criteria, select the at least one URL from the seed database.

In some embodiments, a count of the at least one URL selected from the seed database may be related to at least one of the first count or the second count.

In some embodiments, the at least one processor may cause the system to select the at least one URL from the seed database based on priorities of URLs in the seed database.

In some embodiments, the at least one processor may cause the system to generate a configuration file by parsing the request, the configuration file comprising configuration information relating to one or more tasks associated with the request. The at least one processor may cause the system to store the configuration file in a storage system.

In some embodiments, the at least one processor may cause the system to determine the corresponding crawler module based on configuration information associated with the task. The at least one processor may cause the system to dispatch the task to the corresponding crawler module.

In some embodiments, the corresponding crawler module may be one of a spider crawler module or chrome crawler module.

In some embodiments, the at least one processor may cause the system to extract element information of the at least one web page by parsing, according to configuration information associated with the task, the at least one web page.

In some embodiments, the at least one processor may cause the system to extract one or more linked URLs from the at least one web page by parsing, according to configuration information associated with the task, the at least one web page. The at least one processor may cause the system to store the one or more extracted linked URLs in the seed database.

In some embodiments, the at least one processor may cause the system to push the at least one web page into a message queue. The at least one processor may cause the system to pop the at least one web page from the message queue. The at least one processor may cause the system to extract the one or more linked URLs from the at least one web page.

In some embodiments, the at least one processor may cause the system to store the at least one web page in the file system. The at least one processor may cause the system to obtain the at least one web page from the file system offline. The at least one processor may cause the system to extract the one or more linked URLs from the at least one web page.

In some embodiments, the at least one processor may cause the system to fetch, using one or more proxies of a proxy module, the at least one web page according to the URL associated with the task, each proxy having an Internet protocol (IP) address.

In some embodiments, the at least one processor may cause the system to adjust a count of concurrent fetch requests or a crawling frequency based on a count of effective IP addresses in the proxy module.

In some embodiments, the at least one processor may cause the system to initiate a container for implementing one or more tasks associated with the request.

In some embodiments, the file system may be a Hadoop distributed file system (HDFS).

According to another aspect of the present disclosure, a method may include one or more of the following operations performed by at least one processor. The method may include responsive to receiving a request comprising one or more uniform resource locators (URLs), storing the one or more URLs in a seed database. The method may include selecting at least one URL from the seed database based on a first count of tasks waiting to be executed. The method may include generating a task based on each of the at least one selected URL. The method may include dispatching the task to a corresponding crawler module to cause the crawler module to fetch at least one web page according to an URL associated with the task. The method may include extracting element information of the at least one web page by parsing the at least one web page. The method may include storing the element information in a file system.

According to still another aspect of the present disclosure, a non-transitory computer readable medium may include at least one set of instructions for web crawling. When executed by one or more processors of a computing device, the at least one set of instructions causes the computing device to perform a method. The method may include responsive to receiving a request comprising one or more uniform resource locators (URLs), storing the one or more URLs in a seed database. The method may include selecting at least one URL from the seed database based on a first count of tasks waiting to be executed. The method may include generating a task based on each of the at least one selected URL. The method may include dispatching the task to a corresponding crawler module to cause the crawler module to fetch at least one web page according to an URL associated with the task. The method may include extracting element information of the at least one web page by parsing the at least one web page. The method may include storing the element information in a file system.

According to some systems and methods for cloud computing of the present disclosure, webpage data and/or website data may be fetched. The cloud computing system may support the fetching of the entire network data and may have a relatively high universality. The maintenance and operating cost may be reduced, and the reliability of fetching effective data may be improved. Crawling pressure may be controlled precisely during the fetching process. In addition, flexible editable interface for container expansion and/or container shrinkage may be provided for user(s). The fetched data may be stored in a Hadoop distributed file system (HDFS), and data interaction pressure may be relatively low and data reading efficiency may be relatively high.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary cloud computing system according to some embodiments of the present disclosure;

FIG. 2 is a schematic diagram illustrating exemplary components of a computing device on which the server, the storage device, and/or the terminal device may be implemented according to some embodiments of the present disclosure;

FIG. 3 is a schematic diagram illustrating exemplary hardware and/or software components of an exemplary computing device on which the terminal device 130 may be implemented according to some embodiments of the present disclosure;

FIG. 4 is a block diagram illustrating an exemplary cloud computing system according to some embodiments of the present disclosure;

FIG. 5 is a block diagram illustrating another exemplary cloud computing system according to some embodiments of the present disclosure;

FIG. 6 is a schematic diagram illustrating an exemplary data interaction process of the cloud computing system according to some embodiments of the present disclosure;

FIG. 7 is a flowchart illustrating an exemplary process for web crawling according to some embodiments of the present disclosure; and

FIG. 8 is a flowchart illustrating an exemplary process for discovering link(s) according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operations and functions of the related elements of structure and the combination of parts and economies of manufacture, may become more apparent upon consideration of the following description with reference to the accompanying drawings, all of which form part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowcharts may be implemented not in order. Conversely, the operations may be implemented in inverted order, or simultaneously. Moreover, one or more other operations may be added to the flowcharts. One or more operations may be removed from the flowcharts.

An aspect of the present disclosure relates to a system for cloud computing. The system may include an application program interface (API), a seed database, a job generator, and a crawler module. The API may be configured to provide a user interface to obtain a crawling job submitted by a user. The seed database, in communication with the API, may be configured to store one or more uniform resource locators (URLs) associated with the crawling job. The job generator, in communication with the seed database, may be configured to obtain the one or more URLs and to dispatch each of the one or more URLs to a corresponding crawler module. The crawler module, in communication with the job generator, may be configured to fetch website data and/or webpage data based on the one or more URLs.

Another aspect of the present disclosure relates to a method for web crawling. The method may include responsive to receiving a request comprising one or more uniform resource locators (URLs), storing the one or more URLs in a seed database. The method may also include selecting at least one URL from the seed database based on a first count of tasks waiting to be executed. The method may also include generating a task based on each of the at least one selected URL. The method may further include dispatching the task to a corresponding crawler module to cause the crawler module to fetch at least one web page according to an URL associated with the task. The method may still further include extracting element information of the at least one web page by parsing the at least one web page. The method may also include storing the element information in a file system.

According to the systems and methods of the present disclosure, webpage data and/or website data may be fetched. The fetching of the entire network data may be realized, showing a relatively high universality. The maintenance and operating cost may be reduced, and the reliability of fetching effective data may be improved. Crawling pressure may be controlled precisely during the fetching process. In addition, container used in systems and methods may be dynamically managed. The fetched data may be stored in a Hadoop distributed file system (HDFS), and data interaction pressure may be relatively low and data reading efficiency may be relatively high. Therefore, systems and methods for web crawling securely, efficiently, and cost-effectively may be realized.

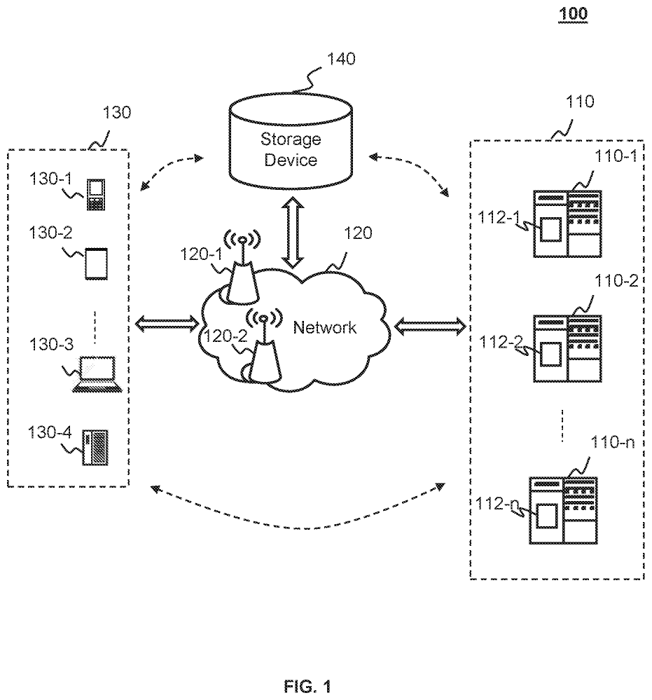

FIG. 1 is a schematic diagram illustrating an exemplary cloud computing system according to some embodiments of the present disclosure. The cloud computing system 100 may include a server 110, a network 120, a terminal device 130, and/or a storage device 140. The components in the cloud computing system 100 may be connected in one or more of various ways. Merely by way of example, the server 110 may be connected to at least a portion of the terminal device 130 through the network 120. As another example, the server 110 may be connected to at least a portion of the terminal device 130 directly as indicated by the bi-directional arrow in dotted lines linking the server 110 and the terminal device 130. As still another example, the storage device 140 may be connected to the server 110 directly or through the network 120. As still another example, the storage device 140 may be connected to at least a portion of the terminal device 130 directly or through the network 120.

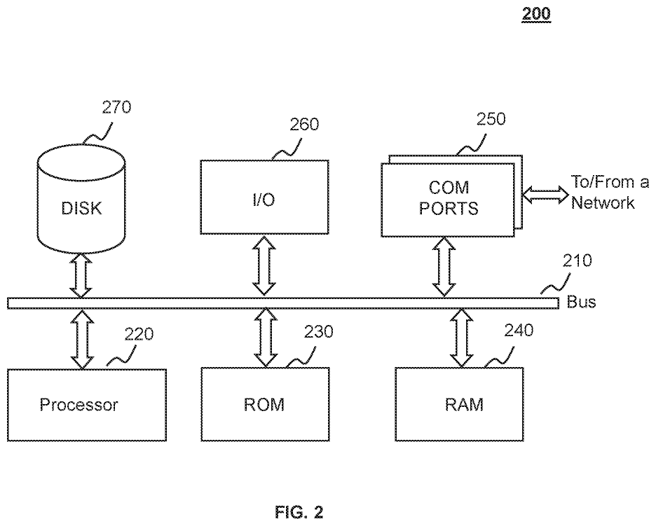

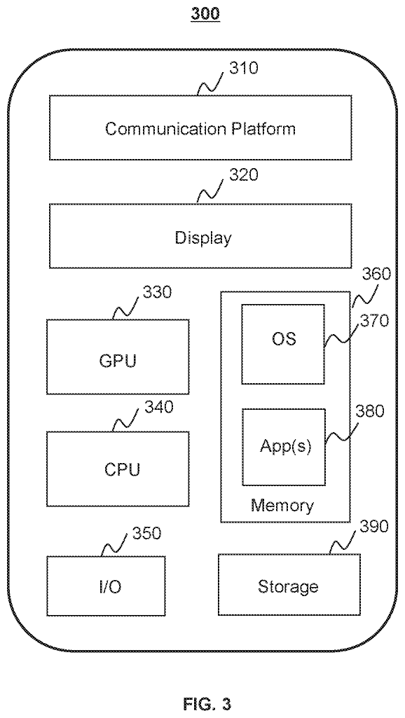

In some embodiments, the server 110 may be a server group. The server group may be centralized, or distributed (e.g., a distributed system). For example, the server 110 may include a server 110-1, a server 110-2, . . . , and a server 110-n. In some embodiments, the server 110 may be local or remote. For example, the server 110 may access information and/or data stored in the terminal device 130, and/or the storage device 140 via the network 120. As another example, the server 110 may be directly connected to the terminal device 130, and/or the storage device 140 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure or a mobile device 300 having one or more components illustrated in FIG. 3 in the present disclosure.

In some embodiments, each of the server 110 may include a processing engine 112. For example, the server 110-1 may include a processing engine 112-1, the server 110-2 may include a processing engine 112-2, . . . , and the server 110-n may include a processing engine 112-n. The processing engine 112 (e.g., the processing engine 112-1, the processing engine 112-2, the processing engine 112-n) may process information and/or data to perform one or more functions described in the present disclosure. For example, the processing engine 112 may receive a request including one or more URLs from a user. As another example, the processing engine 112 may store the one or more URLs in a seed database. As still another example, the processing engine 112 may generate a configuration file by parsing the request. As still another example, the processing engine 112 may select at least one URL from the seed database based on a first count of tasks waiting to be executed. As still another example, the processing engine 112 may generate a task based on each of the at least one selected URL. As still another example, the processing engine 112 may dispatch the task to a corresponding crawler module to cause the crawler module to fetch at least one web page according to an URL associated with the task. As still another example, the processing engine 112 may extract element information of the at least one web page by parsing the at least one web page. As still another example, the processing engine 112 may store the element information in a file system (e.g., an HDFS). As still another example, the processing engine 112 may extract one or more linked URLs from the at least one web page by parsing the at least one web page. As still another example, the processing engine 112 may store the one or more extracted linked URLs in the seed database.

In some embodiments, the processing engine 112 may include one or more processing engines (e.g., single-core processing engine(s) or multi-core processor(s)). Merely by way of example, the processing engine 112 may include one or more hardware processors, such as a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof.

The network 120 may facilitate the exchange of information and/or data. In some embodiments, one or more components in the cloud computing system 100 (e.g., the server 110, the storage device 140, and the terminal device 130) may send information and/or data to other component(s) in the cloud computing system 100 via the network 120. For example, the processing engine 112 may receive a request for web crawling from the terminal device 130 via the network 120. As another example, the processing engine 112 may obtain one or more URLs from the storage device 140 via the network 120. In some embodiments, the network 120 may be any type of wired or wireless network, or a combination thereof. Merely by way of example, the network 120 may include a cable network, a wireline network, an optical fiber network, a telecommunications network, an intranet, the Internet, a local area network (LAN), a wide area network (WAN), a wireless local area network (WLAN), a metropolitan area network (MAN), a wide area network (WAN), a public telephone switched network (PSTN), a Bluetooth™ network, a ZigBee network, a near field communication (NFC) network, or the like, or any combination thereof. In some embodiments, the network 120 may include one or more network access points. For example, the network 120 may include wired or wireless network access points such as base stations and/or Internet exchange points 120-1, 120-2, . . . , through which one or more components of the cloud computing system 100 may be connected to the network 120 to exchange data and/or information.

In some embodiments, the terminal device 130 may include a mobile device 130-1, a tablet computer 130-3, a laptop computer 130-3, a telephone 130-4, or the like, or any combination thereof. In some embodiments, the mobile device 130-1 may include a smart home device, a wearable device, a mobile equipment, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a bracelet, footgear, glasses, a helmet, a watch, clothing, a backpack, a smart accessory, or the like, or any combination thereof. In some embodiments, the mobile equipment may include a mobile phone, a personal digital assistance (PDA), a gaming device, a navigation device, a point of sale (POS) device, a laptop, a desktop, or the like, or any combination thereof. In some embodiments, the virtual reality device and/or the augmented reality device may include a virtual reality helmet, a virtual reality glass, a virtual reality patch, an augmented reality helmet, augmented reality glasses, an augmented reality patch, or the like, or any combination thereof. For example, the virtual reality device and/or the augmented reality device may include a Google Glass™, a RiftCon™, a Fragments™, a Gear VR™, etc.

The storage device 140 may store data and/or instructions. In some embodiments, the storage device 140 may store data obtained from the terminal device 130 and/or the processing engine 112. For example, the storage device 140 may store a request including one or more URLs received from the terminal device 130. As another example, the storage device 140 may store element information of at least one web page determined by the processing engine 112. As still another example, the storage device 140 may store one or more linked URLs associated with at least one web page determined by the processing engine 112. In some embodiments, the storage device 140 may store data and/or instructions that the server 110 may execute or use to perform exemplary methods described in the present disclosure. For example, the storage device 140 may store instructions that the processing engine 112 may execute or use to select at least one URL from a seed database based on a first count of tasks waiting to be executed. As another example, the storage device 140 may store instructions that the processing engine 112 may execute or use to generate a task based on each of at least one selected URL. As still another example, the storage device 140 may store instructions that the processing engine 112 may execute or use to dispatch the task to a corresponding crawler module to cause the crawler module to fetch at least one web page according to an URL associated with the task. As still another example, the storage device 140 may store instructions that the processing engine 112 may execute or use to extract element information of the at least one web page by parsing the at least one web page. As still another example, the storage device 140 may store instructions that the processing engine 112 may execute or use to extract one or more linked URLs from at least one web page by parsing the at least one web page.

In some embodiments, the storage device 140 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyrisor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage device 140 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 140 may be connected to the network 120 to communicate with one or more components in the cloud computing system 100 (e.g., the server 110, the terminal device 130). One or more components in the cloud computing system 100 may access the data or instructions stored in the storage device 140 via the network 120. In some embodiments, the storage device 140 may be directly connected to or communicate with one or more components in the cloud computing system 100 (e.g., the server 110, the terminal device 130). In some embodiments, the storage device 140 may be part of the server 110.

It should be noted that the cloud computing system 100 is merely provided for the purposes of illustration, and is not intended to limit the scope of the present disclosure. For persons having ordinary skills in the art, multiple variations or modifications may be made under the teachings of the present disclosure. For example, the cloud computing system 100 may further include a database (or a file system (e.g., an HDFS)), an information source, or the like. As another example, the cloud computing system 100 may be implemented on other devices to realize similar or different functions. However, those variations and modifications do not depart from the scope of the present disclosure.

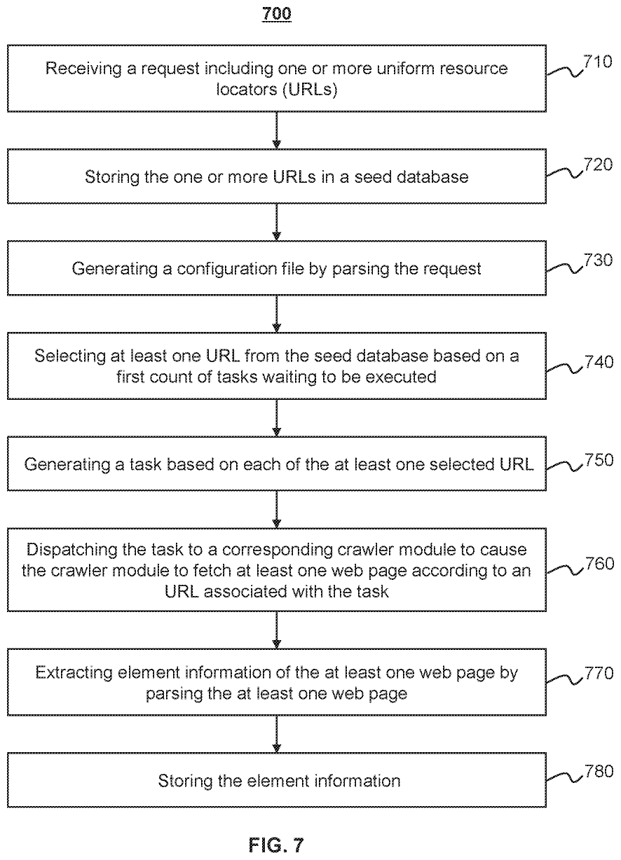

In some embodiments, the cloud computing system 100 may further include a storage system (e.g., the storage system 5212) configured to store configuration file(s) including configuration information relating to crawling job(s). In some embodiments, the storage system may include the storage device 140 or a portion thereof. More descriptions of the configuration file may be found elsewhere in the present disclosure (e.g., FIG. 7, and descriptions thereof). In some embodiments, the cloud computing system 100 and/or the storage system may further include or communicate with a file system (e.g., an HDFS).

In some embodiments, the cloud computing system 100 may run on an operation and maintenance platform (e.g., an operation and maintenance platform on a basis of platform-as-a-service (PAAS)). As used herein, a PAAS may refer to a category of cloud computing services that provides a platform allowing customers to develop, run, and manage applications without the complexity of building and maintaining the infrastructure typically associated with developing and launching an application.

In some embodiments, the operation and maintenance platform may be configured to initiate a container for implementing a crawling job. As used herein, containerization may refer to an operating system feature, and the kernel(s) of the operating system may allow the existence of multiple isolated user-space instances (also referred to as containers). A computer program running on an ordinary operating system may see and/or utilize all resources (e.g., connected devices, files and folders, network shares, CPU power, quantifiable hardware capabilities) of that computer (on which the ordinary operating system runs). However, a computer program running inside a container may only see and/or utilize the container's contents (e.g., data, programs, etc.) and devices (or resources) assigned to the container.

In some embodiments, the operation and maintenance platform may further be configured to manage the container(s) dynamically. For example, if new crawling job(s) are need to be implemented, the operation and maintenance platform may expand the container(s). As another example, if crawling job(s) are finished, the operation and maintenance platform may shrink the container(s).

FIG. 2 is a schematic diagram illustrating exemplary components of a computing device on which the server 110, the storage device 140, and/or the terminal device 130 may be implemented according to some embodiments of the present disclosure. A particular system (e.g., the cloud computing system 100) may use a functional block diagram to explain the hardware platform containing one or more user interfaces. The computer may be a computer with general or specific functions. Both types of the computers may be configured to implement any particular system (e.g., the cloud computing system 100) according to some embodiments of the present disclosure. Computing device 200 may be configured to implement any components that perform one or more functions disclosed in the present disclosure. For example, the computing device 200 may implement any component of the cloud computing system 100 as described herein. In FIGS. 1-2, only one such computer device is shown purely for convenience purposes. One of ordinary skill in the art would understood at the time of filing of this application that the computer functions relating to web crawling as described herein may be implemented in a distributed fashion on a number of similar platforms, to distribute the processing load.

The computing device 200, for example, may include COM ports 250 connected to and from a network connected thereto to facilitate data communications. The computing device 200 may also include a processor (e.g., the processor 220), in the form of one or more processors (e.g., logic circuits), for executing program instructions. For example, the processor may include interface circuits and processing circuits therein. The interface circuits may be configured to receive electronic signals from a bus 210, wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the bus 210.

The exemplary computing device may include the internal communication bus 210, program storage and data storage of different forms including, for example, a disk 270, and a read only memory (ROM) 230, or a random access memory (RAM) 240, for various data files to be processed and/or transmitted by the computing device. The exemplary computing device may also include program instructions stored in the ROM 230, RAM 240, and/or other type of non-transitory storage medium to be executed by the processor 220. The methods and/or processes of the present disclosure may be implemented as the program instructions. The computing device 200 may also include an I/O component 260, supporting input/output between the computer and other components. The computing device 200 may also receive programming and data via network communications.

Merely for illustration, only one CPU and/or processor is illustrated in FIG. 2. Multiple CPUs and/or processors are also contemplated; thus operations and/or method steps performed by one CPU and/or processor as described in the present disclosure may also be jointly or separately performed by the multiple CPUs and/or processors. For example, if in the present disclosure the CPU and/or processor of the computing device 200 executes both operation A and operation B, it should be understood that operation A and operation B may also be performed by two different CPUs and/or processors jointly or separately in the computing device 200 (e.g., the first processor executes operation A and the second processor executes operation B, or the first and second processors jointly execute operations A and B).

FIG. 3 is a schematic diagram illustrating exemplary hardware and/or software components of an exemplary mobile device on which the terminal device 130 may be implemented according to some embodiments of the present disclosure. As illustrated in FIG. 3, the mobile device 300 may include a communication platform 310, a display 320, a graphic processing unit (GPU) 330, a central processing unit (CPU) 340, an I/O 350, a memory 360, and a storage 390. The CPU 340 may include interface circuits and processing circuits similar to the processor 220. In some embodiments, any other suitable component, including but not limited to a system bus or a controller (not shown), may also be included in the mobile device 300. In some embodiments, a mobile operating system 370 (e.g., iOS™, Android™, Windows Phone™) and one or more applications 380 may be loaded into the memory 360 from the storage 390 in order to be executed by the CPU 340. The applications 380 may include a browser or any other suitable mobile apps for receiving and/or rendering information relating to a request or other information from the cloud computing system 100 on the mobile device 300. User interactions with the information stream may be achieved via the I/O devices 350 and provided to the processing engine 112 and/or other components of the cloud computing system 100 via the network 120.

In order to implement various modules, units and their functions described above, a computer hardware platform may be used as hardware platforms of one or more elements (e.g., a component of the sever 110 described in FIG. 2). Since these hardware elements, operating systems, and program languages are common, it may be assumed that persons skilled in the art may be familiar with these techniques and they may be able to provide information required in web crawling according to the techniques described in the present disclosure. A computer with user interface may be used as a personal computer (PC), or other types of workstations or terminal devices. After being properly programmed, a computer with user interface may be used as a server 110 or terminal device 130. It may be considered that those skilled in the art may also be familiar with such structures, programs, or general operations of this type of computer device. Thus, extra explanations are not described for the figures.

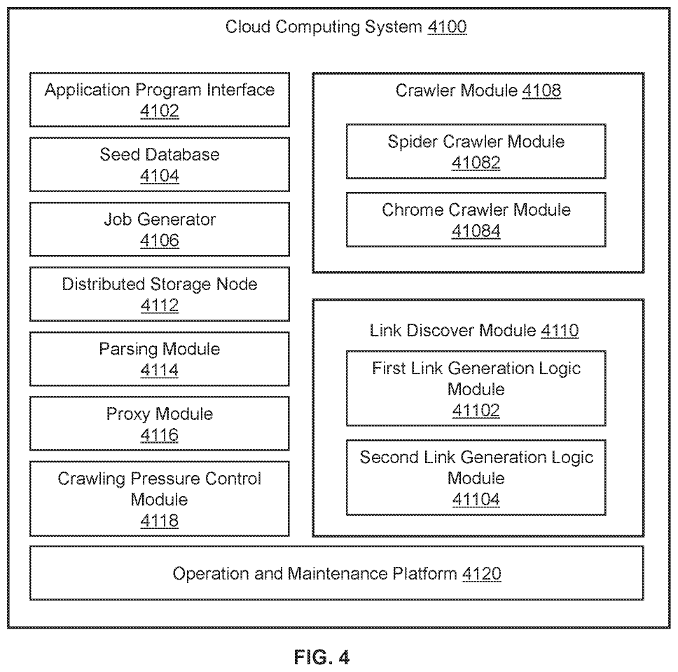

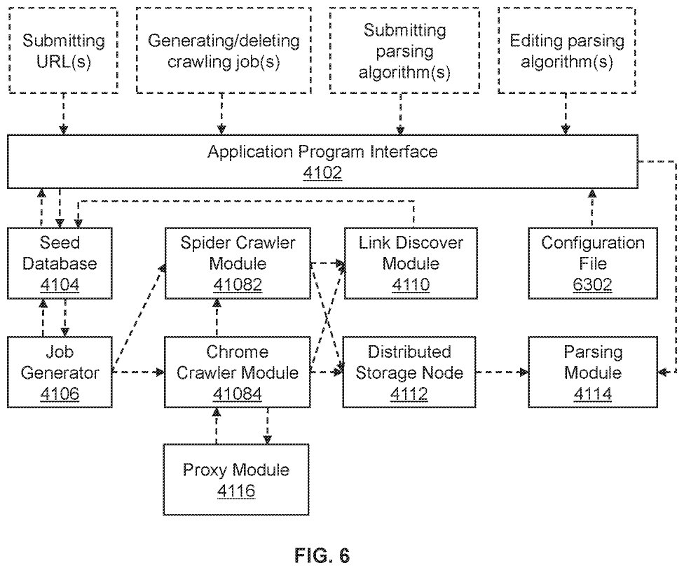

FIG. 4 is a block diagram illustrating an exemplary cloud computing system according to some embodiments of the present disclosure. FIG. 6 is a schematic diagram illustrating an exemplary data interaction process of the cloud computing system according to some embodiments of the present disclosure. The cloud computing system 4100 may include an application program interface (API) 4102, a seed database 4104, a jog generator 4106, a crawler module 4108, a link discover module 4110, one or more distributed storage nodes 4112, a parsing module 4114, a proxy module 4116, and a crawling pressure control module 4118. In some embodiments, the distributed storage node(s) 4112 may be configured in the storage device 140.

In some embodiments, as shown in FIG. 4 and FIG. 6, according to some embodiments of the present disclosure, the cloud computing system 4100 may include: the API 4102 configured to provide a user interface to obtain one or more crawling jobs submitted by one or more users; the seed database 4104, in communication with the API 4102, configured to store one or more URLs associated with the crawling job(s); the job generator 4106, in communication with the seed database 4104, configured to obtain the one or more URLs and/or dispatch each of the one or more URLs to the corresponding crawler module 4108; and the crawler module 4108, in communication with the job generator 4106, configured to fetch website data and/or webpage data based on the one or more URLs. The crawling job(s) may include or be parsed into website crawling job(s) and/or webpage crawling job(s).

In some embodiments, by using the seed database 4104 in the implementation of the webpage crawling job and/or the website crawling job, differences between the webpage crawling job and the website crawling job may be weakened. A user may only need to deliver or submit all the URLs that need to be fetched to the cloud computing system 4100 (e.g., asynchronously), without considering a full break-up of the URLs, an accumulation condition of the website being fetched, or the like. Using the cloud computing system 4100 illustrated above, one or more of the following technical changes may be brought:

(1) An original link selection operation may only need to deal with website crawling job(s). According to the link selection operation disclosed in the present disclosure, website crawling job(s) and webpage crawling job(s) may be processed simultaneously. Unless there is a user-defined link selection logic (or a user-defined link selection rule), because there are no differences in the link selection operations between the website crawling job(s) and the webpage crawling job(s), the link selection logic of the present disclosure may not need to distinguish the website crawling job(s) and the webpage crawling job(s).

(2) The link selection logic of the present disclosure may include constraints of a count of concurrent fetch requests and/or a crawling frequency, to reduce the possibility that the crawling process is discovered by target website(s) to be fetched.

(3) By providing the constraints of the count of concurrent fetch requests, a “per minute link selection” logic may be used, or a “best possible link selection” and delivery strategy may be used instead, in order to make full use of the crawling resources. In addition, the priority of the link selection operation for the webpage crawling jobs) may be higher than the priority of the link selection operation for the website crawling job(s).

A link selection operation may refer to an operation of selecting a URL from the seed database 4104 for web crawling. In some embodiments, the job generator 4106 may perform the link selection operation(s). A link selection logic may refer to a logic or rule of the selection of the URLs from the seed database 4104. In some embodiments, the job generator 4106 may perform the link selection operation based on the link selection logic. As used herein, a “per minute link selection” may refer to that the job generator 4106 may select one or more URLs from the seed database 4104 every minute, and dispatch each of the one or more URLs to the corresponding crawler module 4108. A “best possible link selection” may refer to that the job generator 4106 may select one or more URLs from the seed database 4104 based on a count of tasks waiting to be executed in the crawler module 4108, and/or current available resources in the cloud computing system 4100. More descriptions of the selection of one or more URLs may be found elsewhere in the present disclosure (e.g., FIG. 7, and descriptions thereof).

In some embodiments, the seed database 4104 may provide a corresponding mapping table (e.g., a sub-database) for each specific crawling job, so that the job generator 4106 may deliver the crawling job to the corresponding crawler module 4108 according to the mapping table.

It should be noted that the API 4102 may be implemented as an interface of an API aggregation platform 5202. The API 4102 may provide fetching service(s) for all possible users in a versatile and open manner. In order to improve the reliability of the cloud computing system 4100 of the present disclosure, it may be set to prohibit the user(s) from directly delivering or submitting crawling job(s) to the crawler module 4108.

In some embodiments, the crawler module 4108 may include a spider crawler module 41082 and/or a chrome crawler module 41084. The chrome crawler module 41084 may be configured to perform a JavaScript rendering operation on a rendered web page and/or a user-defined page prior to fetching the webpage data.

In some embodiments, by providing the crawler module 4108 including the spider crawler module 41082 and/or the chrome crawler module 41084, crawling requirements of different users may be met. Specifically, a request for JavaScript rendering operation on the rendered web page and/or the user-defined page may be responded and/or dealt with by using the chrome crawler module 41084. A request for downloading a general html page may be responded and/or dealt with by using the spider crawler module 41082.

Under the consideration of improving crawling performance(s), the spider crawler module 41082 may be used. For example, if the spider crawler module 41082 runs on a 12-core CPU physical machine, several thousands of queries per second (QPS) may be achieved. If the chrome crawler module 41084 runs on the 12-core CPU physical machine, the QPS may be less than ten. In actual crawling scenarios, crawling job(s) without JavaScript rendering operations may account for a large proportion. The platform (e.g., the API 4102, the operation and maintenance platform 4120) may face hundreds of millions of crawling jobs every day, the use of the chrome crawler module 41084 alone may not meet the crawling demand.

It should be noted that the seed database 4104 may provide two kinds of tables (e.g., two databases) for the chrome crawler module 41084 and the spider crawler module 41082. The link selection operations for the chrome crawler module 41084 and the spider crawler module 41082 may be performed by different job generators 4106. Because the crawling pressure control of the chrome crawler module 41084 is different from the crawling pressure control of the spider crawler module 41082, the crawling pressure control of the chrome crawler module 41084 may be implemented by the proxy module 4116 with the hypertext transfer protocol (HTTP).

In some embodiments, a first kind of mapping table may be provided for the chrome crawler module 41084, while a second kind of mapping table may be provided for the spider crawler module 41082. In some embodiments, the parsing module 4114 may parse a crawling job submitted or delivered by a user, and generate a corresponding mapping table (either a first kind of mapping table or a second kind of mapping table) based on the crawling job. In some embodiments, the corresponding mapping table associated with the crawling job may be stored in the seed database 4104. In some embodiments, URLs associated with the crawling job may be recorded in the corresponding mapping table. In some embodiments, the job generator 4106 may determine to which crawler module (the chrome crawler module 41084 or the spider crawler module 41082) the URL(s) in the seed database 4104 may be delivered based on the corresponding mapping table associated with the crawling job.

In addition, in order to optimize the delivery efficiency of the job generator 4106, the spider crawler module 41082 may be configured to show or provide congestion information of website crawling job(s) to an upstream module (e.g., the job generator 4106). For a non-html page, the JavaScript rendering operation may be performed by a browser kernel of the chrome crawler module 41084, and then a fetching operation may be performed to fetch effective webpage data of the non-html page.

In some embodiments, the cloud computing system 4100 may further include a link discover module 4110, in communication with the crawler module 4108 and/or the seed database 4104. The link discover module 4110 may be configured to determine a link crawl depth of the crawling job by parsing the website data and/or the webpage data fetched by the crawler module 4108; update the crawling job based on the link crawl depth; and feed back the updated crawling job to the seed database 4104.

In some embodiments, the link crawl depth of the crawling job may be determined by parsing the website data and/or the webpage data fetched by the crawler module 4108. The crawling job may be updated based on the link crawl depth. The updated crawling job may be fed back to the seed database 4104. In particular, for website crawling job(s), the link crawl depth may indicate a depth-first search strategy, which means that the crawler module 4108 may start to fetch data from a start page, to a first page associated with a first linked URL included in the start page, and then to a second page associated with a second linked URL included in the first page, and so on.

More descriptions of the depth-first search strategy may be found elsewhere in the present disclosure (e.g., FIG. 7 and descriptions thereof).

In some embodiments, the link discover module 4110 may include a first link generation logic module 41102. The first link generation logic module 41102 may be configured to determine the link crawl depth of the crawling job by parsing, in real time, a first copy file of the website data and/or a second copy file of the webpage data fetched by the crawler module 4108; update the crawling job based on the link crawl depth; and feed back the updated crawling job to the seed database in real time.

In some embodiments, by providing the first link generation logic module 41102 in the cloud computing system 4100, a link discover scheme with a relatively high real-time performance may be provided. That is, the link crawl depth of the crawling job may be determined by parsing, in real time, the first copy file of the website data and/or the second copy file of the webpage data fetched by the crawler module 4108. The crawling job may be updated based on the link crawl depth. The updated crawling job may be fed back to the seed database 4104 in real time.

In some embodiments, the cloud computing system 4100 may further include one or more distributed storage nodes 4112, in communication with the one or more crawler modules 4108. The distributed storage node(s) 4112 may be configured to distributedly store element information associated with the fetched website data and/or the fetched webpage data according to a preset directory.

In some embodiments, by providing the one or more distributed storage nodes 4112 in the cloud computing system 4100, the handling capacity and fault tolerance of the cloud computing system 4100 of the embodiments of the present disclosure may be effectively improved. Specifically, the distributed storage node(s) 4112 may include or be part of a distributed file system (e.g., an HDFS). The HDFS may be suitable for operating in a general-purpose and low-cost hardware system. In addition, the HDFS may also be suitable for batch processing of data, which may provide a relatively high aggregated data bandwidth for the cloud computing system 4100. For example, a cluster may support or include hundreds of nodes, and the cluster may also support tens of millions of files. The file size of the files may reach terabytes.

In some embodiments, the link discover module 4110 may include a second link generation logic module 41104, in communication with the one or more distributed storage nodes 4112. The second link generation logic module 41104 may be configured to determine, offline and according to a predetermined schedule, one or more feature values corresponding to the element information stored in the one or more distributed storage nodes 4112; determine a link crawl depth based on the one or more feature values corresponding to the element information; update the crawling job based on the link crawl depth; and feed back the updated crawling job to the seed database 4104.

In some embodiments, by providing the second link generation logic module 41104 in the link discover module 4110, in combination with the distributed storage node(s) 4112, the link discover operation may be performed on the element information in batches offline.

In some embodiments, the feature value(s) of the element information may include a frame parameter, an identification parameter, a label parameter, a type parameter, a text parameter, an index parameter, or the like, or any combination thereof.

In some embodiments, text information associated with the fetched webpage data may be directly obtained according to the feature value(s) of the fetched webpage data. For example, the element information associated with the webpage data may include the feature value(s). The text information corresponding to the feature value(s) of the webpage data may be directly obtained by using an HtmlGet command.

In some embodiments, the predetermined schedule may be set manually by a user, or determined by one or more components of the cloud computing system 4100 according to default settings. In some embodiments, the predetermined schedule may be 0.5 hours, 1.0 hour, 2.0 hours, or the like.

In some embodiments, the cloud computing system 4100 may include a parsing module 4114, in communication with the one or more distributed storage nodes 4112. The parsing module 4114 may be configured to convert the element information into a specified format using one or more preset parsing algorithms; and store the element information in the specified format in the one or more distributed storage nodes 4112.

In some embodiments, the parsing module 4114 may be in communication with the API 4102. The API 4102 may obtain one or more parsing algorithms submitted by user(s). The one or more submitted parsing algorithms may be designated as the one or more preset parsing algorithms and may be stored in the parsing module 4114.

In some embodiments, the parsing module 4114 in communication with the API 4102 may be provided, the API 4102 may be further configured to obtain one or more parsing algorithms submitted by user(s), the one or more submitted parsing algorithms may be designated as the one or more preset parsing algorithms and may be stored in the parsing module 4114, and thus, the universality of the cloud computing system 4100 may be improved.

In some embodiments, the cloud computing system 4100 may include a proxy module 4116, in communication with the crawler module 4108. The proxy module 4116 may be configured to collect and verify one or more proxies with HTTPs (e.g., proxies overseas (e.g., proxies outside China)); and cooperate with the crawler module 4108 to fetch the website data and/or the webpage data based on the one or more URLs (e.g., outside China).

In some embodiments, by providing the proxy module 4116 in the cloud computing system 4100, the concealment of the crawling of the website data and/or the webpage data (e.g., outside China) may be improved. Specifically:

(1) Free and/or charged domestic and/or international proxies with HTTPs may be collected, classified, stored, and managed.

(2) An HTTP flow of the crawler module 4108 may be captured (i.e., a flow interception may be performed) in a transparent manner, which may achieve transparency and decoupling regarding the crawler module 4108, and ensure the universality (e.g., of the proxy module 4116, or the cloud computing system 4100), The flow interception may include rewriting a connect operation via a dynamic link library (e.g., a .so file), modifying a table of IP addresses, etc.

(3) An interface provided by the cloud computing system 4100 to the outside (e.g., the user(s)) may be in compliance with a standard proxy protocol, which may ensure the universality (e.g., of the proxy module 4116). Any module that uses HTTP proxy may directly access (without flow interception) to the cloud computing system 4100.

(4) The managed HTTP proxies (e.g., the HTTP proxies managed by the proxy module 4116) may need to be continually supplemented and the validity of the proxies may need to be verified.

(5) The proxy module 4116 itself may provide a retry mechanism to improve the reliability of the fetched results (e.g., the fetched webpage data, the fetched website data).

(6) In addition to providing proxy IP addresses randomly, the proxy module 4116 may also support an advanced IP address allocation strategy, such as a user-specific IP address pool, an IP address pool that is allowed to be refreshed, etc.

(7) In addition to providing proxy services, the proxy module 4116 may also provide a unified export for crawling web data. Therefore, the crawling pressure control for the chrome crawler module 41084 and/or the spider crawler module 41082 may be implemented by the proxy module 4116.

In some embodiments, the unified export for crawling web data may refer that the fetching operations of the cloud computing system 4100 from target website(s) may be uniformly performed via the proxy module 4116.

In some embodiments, the proxy module 4116 may further be configured to provide a crawling pressure control for the chrome crawler module 41084. The URL(s) that the chrome crawler module 41084 supports for crawling may include one or more user-defined logic algorithms.

In some embodiments, the URL(s) that the chrome crawler module 41084 supports for crawling may include one or more URLs generated, determined, or selected (from the seed database 4104) using user-defined logic algorithm(s).

In some embodiments, the cloud computing system 4100 may include a crawling pressure control module 4118, in communication with the crawler module 4108. The crawling pressure control module 4118 may be configured to control, according to a preset count of concurrent fetch requests and/or a preset crawling frequency, the crawler module 4108 to fetch website data and/or webpage data.

More descriptions of the count of concurrent fetch requests and the preset crawling frequency may be found elsewhere in the present disclosure (e.g., FIG. 7, and descriptions thereof).

In some embodiments, by providing the crawling pressure control module 4118 in the cloud computing system 4100, the count of concurrent fetch requests and/or the crawling frequency of the crawling process may be controlled to reduce the possibility of the crawling process being discovered by target website(s) to be fetched.

In some embodiments, the cloud computing system 4100 may run on an operation and maintenance platform on a basis of platform-as-a-service (PAAS) 4120 (also referred to as a PAAS operation and maintenance platform 4120).

In some embodiments, by setting the cloud computing system 4100 to run on the PAAS operation and maintenance platform 4120 (also referred to as a PAAS platform), at least one of the following technical effects may be achieved:

(1) Containerization of service instance(s) may be realized. The purpose of the containerization of the service instance(s) may include facilitating service migration, realizing isolation of environments and resources when the service instance(s) are running, and facilitating subsequent automated deployment, monitoring, and/or service maintenance, which may be important for implementing the PAAS platform. In addition, container(s) of service process(es) may be considered as sandbox(es) for user(s) to execute custom code logic(s). An exemplary solution to realize containerization may include a Docker.

(2) A one-click deployment and convenient operation and maintenance may be realized. That is, an HTTP API interface may be provided, and a web-side control may also be provided, which may allow user(s) to perform operations such as application creation, application management, application offline, etc.

(3) A mechanism for automatic expansion and/or shrinkage of the container(s), or an interface that may perform similar function(s) may be provided. The PAAS platform may provide an automatic container expansion and/or container shrinkage mechanism, which may be completely or partially shielded by the PAAS platform. For example, the PARS platform may expose the mechanism via a customization interface to the user(s), so that the user(s) may utilize the mechanism via the customization interface. As another example, the PAAS platform may expose a control interface for container expansion and/or shrinkage, the specific strategy (or strategies) may be implemented or provided by the user(s), and thus, the user(s) may provide specific or custom scheme(s) via the control interface to control container expansion and/or shrinkage.

(4) Flexible life cycle(s) of the service instance(s) may be realized. An ideal PARS platform may provide one or more service modes including, for example, an offline service and/or an online service.

For offline service(s), a service instance may be generally a computing module. The service instance(s) of offline service(s) may have no long life cycle requirement. There may be no mandatory requirement for the life cycle of the service instance(s) of the offline service(s). The service instance(s) may only need to complete corresponding computing task(s) within a certain time period. In this situation, the PAAS platform may only need to provide concurrent control of coarse-grained computing task(s).

For online service(s), there may be two situations. In some embodiments, an indefinite number of instances may be maintained. If the instance(s) are web service(s), request(s) (or crawling jobs) may be distributed to an instance with the least pressure (e.g., computing pressure) based on the pressure(s) of the instance(s). If the pressure(s) of the instance(s) exceed a certain level, the number of the instances may be expanded automatically. This mode may be suitable for a public web service module, such as the spider crawler module 41082 that do not require user isolation. In some embodiments, the number (or count) of the maintained instances may be equal to the current number of requests (or crawling jobs). An isolated instance may be initiated for processing each request (or crawling job). This mode may be suitable for scenarios where each request (or crawling job) requires resource(s) isolated from other requests (or crawling jobs). An exemplary scenario may refer that each request (or crawling job) may include a long-term and complex link selection logic.

In some embodiments, the request(s) may refer to crawling job(s) submitted by the user(s). In some embodiments, the request(s) may refer to request(s) initiated in the interactions between components of the PAAS platform or components of the cloud computing system 4100 to implement the crawling job(s) submitted by the user(s).

(5) The PARS platform may shield the implementation of a service discovery. That is, due to the containerization of service instance(s) in the PAAS platform, and automatic scheduling of the service instance(s) by the PAAS platform, for online service(s), the service discovery mechanism which may expose service(s) to outside may be implemented by the PAAS platform.

As used herein, a service discovery may refer to an automatic detection of device(s) and/or service(s) offered by device(s) on a computer network or in the cloud computing system 4100. An exemplary service discovery may include a link discovery. In some embodiments, the outside may refer to the outside of the PAAS platform or the outside of the cloud computing system 4100.

(6) A sophisticated monitoring mechanism may be provided. The monitoring mechanism may include a monitoring of an instance number, a monitoring of resource(s) (e.g., a CPU resource, a memory, a bandwidth) occupied by instance(s), a log monitoring, or the like.

The modules in the cloud computing system 4100 may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. In some embodiments, two or more of the modules may be combined into a single module, or any one of the modules may be divided into two or more units. For example, the cloud computing system 4100 may further include a storage system configured to store configuration file(s) including configuration information relating to the crawling job(s). As another example, the cloud computing system 4100 may further include a control module configured to control the implementation of the crawling job(s) submitted by the user(s).

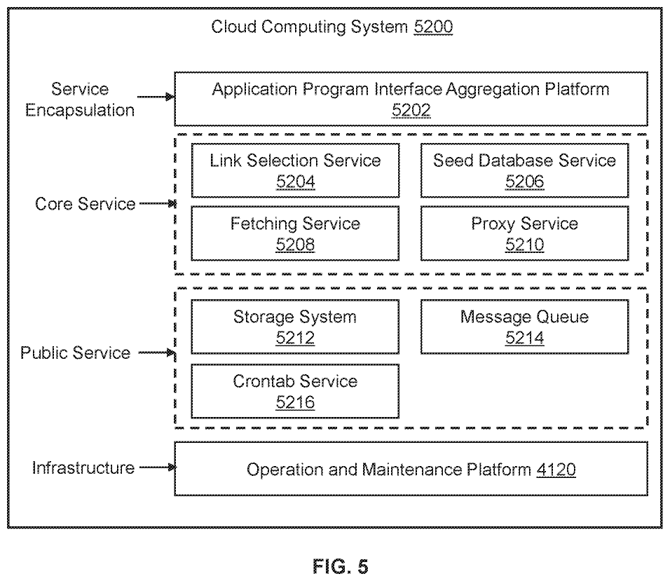

FIG. 5 is a block diagram illustrating another exemplary cloud computing system according to some embodiments of the present disclosure. FIG. 6 is a schematic diagram illustrating an exemplary data interaction process of the cloud computing system according to some embodiments of the present disclosure. The cloud computing system 5200 may include an API aggregation platform 5202 in communication with the operation and maintenance platform 4120. The cloud computing system 5200 may provide one or more core services and/or one or more public services. In some embodiments, the core service(s) and/or the public service(s) may run on the operation and maintenance platform 4120. The core services may include a link section service 5204, a seed database service 5206, a fetching service 5208, a proxy service 5210, etc. In some embodiments, the core services may include a parsing service (not shown). The public service may include a storage system 5212, a message queue 5214, a crontab service 5216, etc.

As shown in FIG. 5 and FIG. 6, according to some embodiments of the present disclosure, the cloud computing system 5200 may include a webpage crawling sub-system and/or a webpage parsing sub-system. The functions of the two sub-systems may be independent. Data streams (associated with the two sub-systems) may be decoupled by the HDFS. Job management systems associated with the two sub-systems may be executed separately.

In some embodiments, the webpage crawling sub-system may include the seed database 4104, the job generator 4106, the crawler module 4108, the proxy module 4116, and the crawling pressure control module 4118. In some embodiments, the webpage parsing sub-system may include the link discover module 4110, and the parsing module 4114.

As shown in FIG. 4 and FIG. 6, the webpage crawling sub-system may obtain one or more URLs submitted via the API 4102, and/or one or more instructions or requests to generate/delete crawling job(s) via the API 4102. The webpage parsing sub-system may obtain one or more parsing algorithms/applications submitted via the API 4102, and/or instructions or requests to edit the parsing algorithm(s)/application(s) via the API 4102.

Specifically, in some embodiments, job(s) submitted by user(s) via a webpage or the API aggregation platform 5202 may include two portions. In some embodiments, a first portion of the job(s) may refer to crawling job(s) (e.g., created or submitted by user(s)) that may use function(s) (or service(s)) of webpage crawling, website crawling, and/or storage (e.g., in an HDFS). In some embodiments, a second portion of the job(s) may refer to parsing job(s). If user(s) need to use a parsing function (or service) (of the cloud computing system 5200), the user(s) may create parsing job(s), and specify parsing data source(s) (e.g., an HDFS, a time-efficient storage system), a storage location for parsing result(s), or a system-provided or custom parsing algorithm package, or the like.

The API aggregation platform 5202 may be a service encapsulation provided for the API 4102 shown in FIG. 4. That is, the webpage crawling sub-system and the webpage parsing sub-system may provide corresponding service(s) to outside separately. The webpage crawling sub-system and the webpage parsing sub-system may provide HTTP service(s) to the outside through the API aggregation platform 5202 uniformly.

The core services may include a link selection service 5204, a seed database service 5206, a fetching service 5208, and a proxy service 5210.

Components of the webpage crawling sub-system that provide core service(s) may include a seed database (e.g., the seed database 4104), a default link selection module (e.g., the job generator 4106), a webpage download module (i.e., a fetcher), a chrome crawler module (e.g., the chrome crawler module 41084), a link discover module (e.g., the link discover module 4110), and a proxy module (e.g., the proxy module 4116).

In the present disclosure, the seed database may be commonly used in website crawling job(s) and webpage crawling job(s). There is no difference between the website crawling job(s) and the webpage crawling job(s) in the use of the seed database. However, link selection priorities for the website crawling job(s) and the webpage crawling job(s) may be different. For example, the link selection priority for the webpage crawling job(s) may be higher than that of the website crawling job(s). In the website crawling job(s), a per minute link selection logic may be used in link selection operation(s). Alternatively, in some embodiments, links may be delivered as much as possible under a crawling concurrency control of the job generator (e.g., a best possible link selection and delivery strategy may be used in link selection operation), thereby making full use of the crawling ability of the cloud computing system 5200, and allowing each user's webpage crawling job(s) and/or website crawling job(s) to be implemented at a maximum speed.

In some embodiments, referring to the feasibility analysis of a service on a basis of software as a service (SAAS) of the seed database, the seed database disclosed in the present disclosure may not be isolated (from the cloud computing system 5200 or the API aggregation platform 5202), and a custom link selection logic may not be used. In some embodiments, the seed database disclosed in the present disclosure may allow a simple traversal operation on the links (or URLs) stored in the seed database. In some embodiments, the seed database may not allow user(s) to customize link selection operation(s).

In some embodiments, the seed database may not the used in the cloud computing system 4100 or 5200. In some embodiments, user(s) may be allowed to customize link selection operation(s).

Therefore, there may be one or more alternatives to a seed database that is isolated (from the cloud computing system 5200 or the API aggregation platform 5202) and allow a custom link selection logic. A QPS restriction of the API aggregation platform 5202 may be used to prevent user(s) from attacking the seed database. User(s) may not be allowed to query the seed database by submitting server-side script(s). If user(s) want to customize the link selection operation(s), the user(s) may use the link selection service 5204 (e.g., service(s) provided by the seed database and/or the job generator) provided by the platform, or the user(s) may need to provide a custom link selection service (including a seed database and a job generator) to the platform. In some embodiments, the platform (the API aggregation platform 5202) may open an interface for the user(s) to deliver information (e.g., URL(s)) to a spider crawler module (e.g., the spider crawler module 41082). The user(s) may deliver URL(s) by using a webpage crawling manner, and service(s) may be deployed by the user(s). Alternatively, the user(s) may deliver the URL(s) through the PAAS platform.

An external interface of the webpage crawling sub-system may only be opened to upstream module(s) of the seed database. In principle, the user(s) cannot submit URL(s) directly to a spider crawler module (e.g., the spider crawler module 41082). In addition, in order to achieve an optimal delivery strategy of the job generator (e.g., the job generator 4106), the spider crawler module (e.g., the spider crawler module 41082) may provide a congestion condition of the fetching of each website to an upstream module (e.g., the job generator 4106).

In the implementation of the fetching service 5208, the fetching service 5208 may include a spider crawler service and a chrome crawler service. Specifically, a request for JavaScript rendering operation on the rendered web page and/or the user-defined page may be responded and/or dealt with by using the chrome crawler service. A request for downloading a general html page may be responded and/or dealt with by using the spider crawler service. The spider crawler service may be used for performance reasons. For example, if the spider crawler service runs on a 12-core CPU physical machine, several thousands of QPS may be achieved. If the chrome crawler service runs on the 12-core CPU physical machine, the QPS may be less than ten. In actual crawling scenarios, crawling job(s) without JavaScript rendering operations may account for a large proportion. The platform (e.g., the API aggregation platform 5202) may face hundreds of millions of crawling jobs every day, the use of the chrome crawler service alone may not meet the crawling demand. The chrome crawler service and the spider crawler service may be completely separate. The function differentiation of the chrome crawler service and the spider crawler service may be reflected or considered in the seed database service 5206. The seed database service 5206 may provide two kinds of tables (e.g., two databases) for the chrome crawler service and the spider crawler service. Link selection operations for the chrome crawler service and the spider crawler service may be performed by different job generators. Because the crawling pressure control of the chrome crawler service is different from the crawling pressure control of the spider crawler service, the crawling pressure control of the chrome crawler service may be implemented by a proxy module with HTTPs.

The proxy service 5210 may provide an export for the platform flow. A flow control process of the proxy service 5210 may be described as follows: HTTP proxies and HTTPS proxies in domestic and foreign regions may be collected and verified; one or more reliable proxies may be randomly assigned for each fetch request; and a crawling pressure control may be provided for the chrome crawler service.

Downstream service(s) of the chrome crawler service and/or the spider crawler service may include public service(s). The public service(s) may include a storage system 5212 (e.g., a configuration center), a message queue 5214, and a crontab service 5216. The storage system 5212 may be configured to store parameters related to the crawling pressure control (e.g., parameter(s) may be stored in one or more configuration files 6302 shown in FIG. 6). The parameters may include, for example, a count of concurrent fetch requests, a crawling frequency, etc.

The message queue 5214 may be configured to store a first queue of URLs to be fetched. The crawler module (e.g., the crawler module 4108) may select one or more seed URLs. The crawler module 4108 may put the one or more seed URLs into the first queue of URLs to be fetched. The crawler module 4108 may select a URL from the first queue of URLs to be fetched. The crawler module 4108 may determine an IP address of a host by parsing a domain name server (DNS) corresponding to the selected URL. The crawler module 4108 may download and store original webpage(s) corresponding to the selected URL. The crawler module 4108 may put the selected URL into a second queue of URLs that has been fetched.

In some embodiments, the downloaded original webpage(s) may be stored in the HDFS directly, and the link discover operation may be performed at the same time. There may be two kinds of link discover operations. For example, copy file(s) of the webpage data fetched by the crawler module 4108 may be transmitted to the link discover module 4110 (e.g., the first link generation logic module 41102) to perform an online link discover operation. As another example, an offline link discover module 4110 (e.g., the second link generation logic module 41104) may be created in the webpage parsing sub-system to perform an offline batch processing of the data stored in the HDFS to discover new link(s).

In some embodiments, a link may refer to an URL. In some embodiments, in the online link discover operation, the webpage data fetched by the crawler module 4108 may be stored in a third message queue (e.g., Kafka), and the link discover module 4110 (e.g., the first link generation logic module 41102) may obtain the webpage data from the third message queue, and perform an online link discover operation.

In some embodiments, a fourth message queue may be used to store URLs selected by the link selection service (or the job generator 4106), and the crawler module 4108 may obtain the selected URLs from the fourth message queue. In some embodiments, the new link(s) discovered by the link discover module 4110 (the first link generation logic module 41102 and/or the second link generation logic module 41104) may be stored into a fifth message queue, and the seed database service (or the seed database 4104) may obtain the new link(s) from the fifth message queue and store the new link(s) in the seed database 4104.

The crontab service 5216 may be configured as a pre-service of the job generator (e.g., the job generator 4106). In some embodiments, the crontab service 5216 may belong to a built-in service of a Linux system, and may be configured to control an allocation operation of the job generator 4106 on the crawling job.

In some embodiments, the crontab service 5216 may be configured as a distributed and independent service.

The webpage parsing sub-system may be a parsing system built based on the underlying PAAS platform 4120. The webpage parsing sub-system may have multifunction and may be naturally connected with the webpage crawling sub-system. The webpage parsing sub-system may provide service(s) on a basis of PAAS. If user(s) create parsing template(s) in the webpage parsing sub-system, the webpage parsing sub-system may perform offline parsing tasks in batches and periodically, parse data stored in the HDFS into a user-defined format, and/or store the data in the user-defined format in the HDFS.

An infrastructure of the cloud computing system 5200 may be realized by the PAAS operation and maintenance platform 4120 (i.e., the PAAS platform). Because the webpage crawling job(s) and/or website crawling job(s) may be considered as mirroring operation(s) on dynamic webpage(s), the operation and maintenance platform 4120, functioning as an operation and maintenance platform for instance(s) of other sub-systems, may provide one or more of the following interfaces to outside: A, an interface for creating mirroring; B, an interface for removing mirroring; C, an interface for managing mirroring information; and D, an interface for invoking service(s) provided by the mirroring. For each registered image, an HTTP interface may be provided. The webpage crawling sub-system may invoke corresponding service(s) by calling the HTTP interface.

As used herein, an image may refer to an ordered collection of root filesystem changes and the corresponding execution parameters for use within a container runtime.

The sequence of the operations in the embodiments of the present disclosure may be adjusted, the operations may be merged and/or deleted according to some embodiments of the present disclosure.

The modules and/or units in the terminal device of the present disclosure may be combined, divided, and/or deleted according to some embodiments of the present disclosure.

Those skilled in the art may understand that all or part of the embodiments of the present disclosure may be completed by a program to instruct a related hardware. The program may be stored in a computer readable storage medium, including a read-only memory (ROM), a random access memory (RAM), a programmable read-only memory (PROM), an erasable programmable read only memory (EPROM), an one-time programmable read-only memory (OTPROM), an electronically-erasable programmable read-only memory (EEPROM), a compact Disc read-only memory (CD-ROM), any other optical disc storage, a magnetic disk storage, a magnetic tape storage, or any other medium readable that a computer may be used to carry or store data.

The technical solution of the present disclosure may be described in detail above with reference to the accompanying drawings. The present disclosure may provide a cloud computing system. According to some systems and methods for cloud computing of the present disclosure, webpage data and/or website data may be fetched. The cloud computing system may support the fetching of the entire network data and may have a relatively high universality. The maintenance and operating cost may be reduced, and the reliability of fetching effective data may be improved. Crawling pressure may be controlled precisely during the fetching process. In addition, flexible editable interface for container expansion and/or container shrinkage may be provided for user(s). The fetched data may be stored in a Hadoop distributed file system (HDFS), and data interaction pressure may be relatively low and data reading efficiency may be relatively high.

The above description may be only a preferred embodiment of the present disclosure, and is not intended to limit the present disclosure. Various changes and modifications may be made to the present disclosure. Any modifications, equivalent substitutions, improvements, or the like, made within the spirit and principles of the present disclosure should be covered by the scope of the present disclosure.

The modules in the cloud computing system 5200 may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. In some embodiments, two or more of the modules may be combined into a single module, and any one of the modules may be divided into two or more units.

FIG. 6 is a schematic diagram illustrating an exemplary data interaction process of the cloud computing system according to some embodiments of the present disclosure.

In some embodiments, one or more crawling jobs may be generated (or submitted, or requested), or deleted by one or more users via the API 4102. For example, the user(s) may generate the crawling job(s) by submitting one or more URLs via the API 4102. One or more configuration files 6302 may be generated by parsing the crawling job(s). The configuration file(s) may include configuration information relating to the crawling job(s). The one or more URLs may be stored in the seed database 4104. In some embodiments, the seed database 4104 may store URL(s), priority information of the URL(s), information relating to fetching results (e.g., success, failure) of the URL(s), etc. The job generator 4106 may select at least one URL from the seed database 4104. For example, the job generator 4106 may select at least one URL from the seed database 4104 based on a first count of tasks waiting to be executed in the crawler module 4108, and according to priorities of URLs in the seed database 4104. The job generator 4106 may generate a task based on a selected URL. The job generator 4106 may dispatch the task to a corresponding crawler module (e.g., the spider crawler module 41082, or the chrome crawler module 41084). For example, the job generator 4106 may dispatch the task to the corresponding crawler module based on configuration information associated with the task stored in the configuration file 6302. The crawler module 4108 may fetch at least one web page according to an URL associated with the task. For example, the crawler module 4108 may fetch, using one or more proxies of the proxy module 4116, the at least one web page according to the URL associated with the task. The crawler module 4108 may store the fetched webpage data associated with the at least web page in one or more distributed storage nodes 4112 of a distributed file system (e.g., an HDFS). The parsing module 4114 may extract element information of the at least one web page by parsing the at least one web page. For example, the parsing module 4114 may parse the at least one web page according to one or more parsing algorithms submitted and/or edited by the user(s) via the API 4102. The parsing module 4114 may store the element information in the one or more distributed storage nodes 4112 of the distributed file system (e.g., an HDFS). In some embodiments, the link discover module 4110 may extract one or more linked URLs from the at least one web page by parsing the at least one web page. The link discover module 4110 may store the one or more extracted linked URLs in the seed database 4104.

In some embodiments, before discovering the linked URL(s), the link discover module 4110 may determine whether to discover new link(s) based on corresponding configuration information associated with a crawling job. For example, if the crawling job is a webpage crawling job, the link discover module 4110 may determine not to discover new link(s). As another example, if the crawling job is a website crawling job, the link discover module 4110 may determine to discover new link(s).

In some embodiments, user(s) may configure, through the API4102, component(s) of the webpage crawling sub-system and/or the webpage parsing sub-system, for example, the seed database 4104, the parsing module 4114, the link discover module 4110, etc. In some embodiments, user(s) may configure, through the API 4102, information relating to link discovery (e.g., whether to discover new link(s), online or offline link discovery, etc.). Corresponding configuration information may be stored in the configuration file(s) 6302.

In some embodiments, the seed database 4104, the crawler module 4108, the link discover module 4110, etc. may be implemented separately as a container running on the operation and maintenance platform 4120. In some embodiments, if a user submit a crawling job, the operation and maintenance platform 4120 may initiate one or more containers to implement the crawling job.

FIG. 7 is a flowchart illustrating an exemplary process for web crawling according to some embodiments of the present disclosure. The process 700 may be executed by the cloud computing system 100, the cloud computing system 4100, or the cloud computing system 5200. For example, the process 700 may be implemented as a set of instructions stored in the storage ROM 230 or RAM 240. The processor 220 and/or the modules in FIGS. 4-5 may execute the set of instructions, and when executing the instructions, the processor 220 and/or the modules may be configured to perform the process 700. The operations of the illustrated process presented below are intended to be illustrative. In some embodiments, the process 700 may be accomplished with one or more additional operations not described and/or without one or more of the operations discussed. Additionally, the order in which the operations of the process 700 illustrated in FIG. 7 and described below is not intended to be limiting.

In 710, the application program interface (API) 4102 may receive a request including one or more uniform resource locators (URLs).

In some embodiments, the request may be a request for web crawling. For example, the request may be a crawling job. The crawling job may include a webpage crawling job, and/or a website crawling job. In some embodiments, the request may include one or more URLs. As used herein, a URL (also referred to as a web address) may refer to a reference to a web resource that specifies its location on a computer network and/or a mechanism for retrieving it.

In 720, the server 110 (e.g., the parsing module 4114) may store the one or more URLs in a seed database.

In some embodiments, the server 110 may extract the one or more URLs by parsing the request. The server 110 may store the one or more extracted URLs in the seed database (e.g., the seed database 4104). As used herein, the seed database may refer to a data structure used for the storage of URLs eligible for crawling. The data structure may support operations including, for example, adding URL(s), selecting URL(s) for crawling, etc. In some embodiments, the seed database may include one or more sub-databases (e.g., the mapping table(s) described in FIG. 4). Each sub-database may correspond to a crawling job. The server 110 may store the one or ore URLs associated with a same crawling job in a corresponding sub-database.

In 730, the server 110 (e.g., the parsing module 4114) may generate a configuration file by parsing the request.

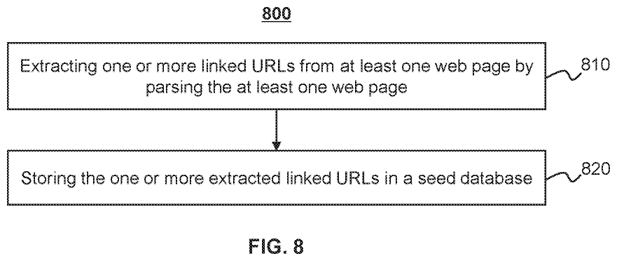

In some embodiments, the configuration file may include configuration information relating to the crawling job. In some embodiments, the configuration information relating to the crawling job may include a user's identity information (e.g., an identification (ID)), a type of the crawling job (e.g., website data crawling and/or webpage data crawling), element information associated with a web page to be extracted, link selection logic, information relating to link discovery, or the like. As used herein, a “webpage data crawling” may refer to a process of fetching data (e.g., a text, an image) in a specific webpage. A “website data crawling” may refer to a process of fetching data (e.g., a text, an image) in a specific website (e.g., one or more webpages of the specific website) and one or more linked URLs associated with the specific webpage(s). More descriptions of the linked URL may be found elsewhere in the present disclosure (e.g., FIG. 8, and descriptions thereof). In some embodiments, the element information associated with a specific web page may include textual information, non-textual information (e.g., a static images, an animated image, an audio, a video), interactive information (e.g., a hyperlink), or the like.

In some embodiments, the server 110 may store the configuration file in a storage system (e.g., the storage system 5212) of the cloud computing system 100 or an external storage system.

In 740, the server 110 (e.g., the job generator 4106) may select at least one URL from the seed database based on a first count of tasks waiting to be executed.

In some embodiments, the server 110 may identify the first count of tasks waiting to be executed. For example, the server 110 may identify the first count of tasks waiting to be executed in a crawler module (e.g., the crawler module 4108). The server 110 may identify a second count of URLs in the seed database (e.g., the seed database 4104). The server 110 may determine whether to select an URL based on the first count and/or the second count. For example, the server 110 may determine whether the first count and/or the second count satisfy one or more criteria. The one or more criteria may include that the first count is less than a first threshold, the second count is greater than a second threshold, or the like. The first threshold may relate to a maximum count limit of tasks waiting to be executed in the crawler module. For example, the first threshold may be equal to the maximum count limit, or the maximum count limit multiplied by a coefficient. The first threshold and/or the second threshold may be set manually by a user, or determined by one or more components of the cloud computing system 100 according to default settings. For example, the second threshold may be 0. In response to a determination that the first count and/or the second count satisfy the one or more criteria, the server 110 may select the at least one URL from the seed database.

In some embodiments, a count of the at least one URL selected from the seed database 4104 may relate to the first count and/or the second count. In some embodiments, the crawler module (e.g., the crawler module 4108) may have a maximum count limit of tasks waiting to be executed. The server 110 may determine the count of the at least one URL selected from the seed database based on the maximum count limit, the first count, and/or the second count. In some embodiments, the count of the at least one URL selected from the seed database 4104 may be no greater than the second count, and/or a difference between the maximum count limit and the first count. Merely by way of example, if the maximum count limit of the tasks waiting to be executed in the crawler module is 10000, the first count is 9000, and the second count is greater than 1000, the server 110 may select 1000 URLs (i.e., 10000−9000=1000) from the seed database.

In some embodiments, the server 110 may select the at least one URL from the seed database based on priorities of URLs in the seed database. The priorities of URLs in the seed database may be set manually by a user, or determined by one or more components of the cloud computing system 100 according to default settings. In some embodiments, the server 110 may select the at least one URL from the seed database based on a length of each URL of the URLs in the seed database. For example, a URL with a relatively short length may have a relatively high priority. In some embodiments, the server 110 may select the at least one URL from the seed database based on a level of each URL of the URLs in the seed database. For example, a URL with a relatively low level may have a relatively high priority. In some embodiments, the server 110 may select the at least one URL from the seed database based on the configuration information relating to the crawling job associated with the URL. For example, a URL associated with a webpage data crawling job may have a relatively high priority.

In 750, the server 110 (e.g., the job generator 4106) generate a task based on each of the at least one selected URL.

In some embodiments, the server 110 may generate the task associated with the selected URL based on the configuration information relating to the task associated with the URL. Each task may correspond to a URL. A crawling job may correspond to a plurality of tasks.

In 760, the server 110 (e.g., the job generator 4106) may dispatch the task to a corresponding crawler module (e.g., the spider crawler module 41082, the chrome crawler module 41084) to cause the crawler module to fetch at least one web page according to an URL associated with the task.

In some embodiments, the server 110 may determine the corresponding crawler module based on configuration information associated with the task. For example, when submitting or generating the crawling job, the user may select a crawler module for each of the one or more URLs included in the crawling job. The selected crawler module corresponding to a specific URL may be stored as part of the configuration information relating to the task associated with the specific URL. The server 110 may dispatch the task to the corresponding crawler module.

In some embodiments, the crawler module may include a spider crawler module (e.g., the spider crawler module 41082), a chrome crawler module (e.g., the chrome crawler module 41084), or the like. The spider crawler module may be a distributed crawler configured to fetch webpage data without performing a JavaScript rendering operation. For example, the spider crawler module may be configured to download HTML page(s). The chrome crawler module may be configured to perform a JavaScript rendering operation on a rendered web page and/or a user-defined page prior to fetching the webpage data. The spider crawler module and the chrome crawler module may have different crawling performances. More descriptions of the difference between the spider crawler module and the chrome crawler module may be found elsewhere in the present disclosure (e.g., FIGS. 4-5 and descriptions thereof).

In some embodiments, the crawler module may fetch the at least one web page according to the URL associated with the task. For example, the crawler module may determine an IP address of a host by parsing a DNS corresponding to the URL. The crawler module may download and/or store the at least one web page corresponding to the URL based on the IP address of the host. In some embodiments, after the web page is downloaded, the server 110 may store the web page in the storage device 140 or a file system (e.g., an HDFS) inside or outside the cloud computing system 100.

In some embodiments, the crawler module may fetch, using one or more proxies of a proxy module (e.g., the proxy module 4116), the at least one web page according to the URL associated with the task. Each proxy may have an Internet protocol (IP) address. In some embodiments, the proxy module may collect a plurality of free and/or charged proxies. The proxy module may verify the security and availability of the collected proxies. The proxy module may store one or more proxies with relatively high security and availability in a proxy pool of the proxy module. The crawler module may be in communicated with the proxy module and may use one or more proxies in the proxy pool of the proxy module to fetch the at least one web page according to the URL associated with the task.

In some embodiments, the server 110 (e.g., the crawling pressure control module 4118) may control the crawler module to fetch the at least one web page according to a preset count of concurrent fetch requests and/or a preset crawling frequency. As used herein, “a count of concurrent fetch requests” may refer to the number of times that a web page is fetched using one or more proxies at one time, or the number of web pages that are fetched using one or more proxies at one time, A “crawling frequency” may refer to the number of times that a web page is fetched per second using one or more proxies, or the number of web pages that are fetched per second using one or more proxies. For example, if it takes 200 milliseconds for the crawler module to fetch a web page using a proxy, and the proxy initiates one fetch request for the web page at one time, the proxy may fetch the web page five times in one second. In this situation, the count of concurrent fetch requests may be 1, and the crawling frequency may be 5. As another example, if it takes 200 milliseconds for the crawler module to fetch a web page using the proxy, and the proxy initiate five fetch requests for the web page at one time, the proxy may fetch the web page five times in one second. In this situation, the count of concurrent fetch requests may be 5, and the crawling frequency may be 5.

In some embodiments, the server 110 may adjust the count of concurrent fetch requests and/or the crawling frequency based on a count of effective proxies (with IP addresses) in the proxy module. For example, if the count of effective proxies in the proxy module is relatively large, the count of concurrent fetch requests of each proxy or the crawling frequency of each proxy may be set relatively low, which may reduce the possibility of the crawling process being discovered and/or blocked by target website(s) being fetched, thereby improving security of the crawling process.

In 770, the server 110 (e.g., the parsing module 4114) may extract element information of the at least one web page by parsing the at least one web page.

In some embodiments, the server 110 may extract the element information of the at least one web page by parsing the at least one web page according to configuration information associated with the task, and one or more preset parsing algorithms (e.g., a parsing tool). Exemplary parsing algorithms may include HTML parser, SGML parser, Jsoup, BeautifulSoup, Readability, or the like. The parsing algorithm may be set manually by a user via the API (e.g., the API 4102, the API aggregation platform 5202), or determined by one or more components of the cloud computing system 100 according to default settings. In some embodiments, the server 110 may extract the element information of the web page according to feature value(s) of the fetched webpage data. More descriptions of the feature value(s) may be found elsewhere in the present disclosure (e.g., FIG. 4 and descriptions thereof).

In 780, the server 110 (e.g., the parsing module 4114) may store the element information. In some embodiments, the server 110 may store the element information in a file system (e.g., an HDFS). For example, the server 110 may store the element information in one or more distributed storage nodes of the HDFS.

In some embodiments, the sever 110 may convert the element information into a specified format using the one or more preset parsing algorithms. For example, the server 110 may convert the element information into a table format. In some embodiments, the server 110 may store the element information in the specified format in the one or more distributed storage nodes of the HDFS.

It should be noted that the above description is merely provided for the purpose of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more operations may be added elsewhere in process 700. For example, a link discover operation (e.g., operations 810 and/or 820 in FIG. 8) may be added in process 700. As another example, one or more storage operations (e.g., the storing of the web page, the configuration file, etc.) may be added in the process 700.

FIG. 8 is a flowchart illustrating an exemplary process for discovering link(s) according to some embodiments of the present disclosure. The process 800 may be executed by the cloud computing system 100, the cloud computing system 4100, or the cloud computing system 5200. For example, the process 800 may be implemented as a set of instructions stored in the storage ROM 230 or RAM 240. The processor 220 and/or the modules in FIGS. 4-5 may execute the set of instructions, and when executing the instructions, the processor 220 and/or the modules may be configured to perform the process 800. The operations of the illustrated process presented below are intended to be illustrative. In some embodiments, the process 800 may be accomplished with one or more additional operations not described and/or without one or more of the operations discussed. Additionally, the order in which the operations of the process 800 illustrated in FIG. 8 and described below is not intended to be limiting.

In 810, the server 110 (e.g., the link discover module 4110) may extract one or more linked URLs from at least one web page by parsing the at least one web page. In some embodiments, the server 110 may extract one or more linked URLs (also referred to as links) from the at least one web page (e.g., the web page fetched in 760).

In some embodiments, the server 110 may extract the linked URL(s) (also referred to as “discover new link(s)”) online. Merely by way of example, the server 110 (e.g., the crawler module 4108) may push the at least one web page into a message queue. As used herein, a message queue may refer to a software-engineering component used for inter-process communication (IPC), or for inter-thread communication within the same process. In some embodiments, the message queue may include a Kafka, Redis, or the like. The server 110 (e.g., the first link generation logic module 41102) may pop the at least one web page from the message queue. The server 110 (e.g., the first link generation logic module 41102) may extract one or more linked URLs from the at least one web page by parsing, according to configuration information relating to the task associated with the at least one web page, the at least one web page. For example, the server 110 (e.g., the first link generation logic module 41102) may determine a link crawl depth of the task by parsing the at least one web page. In some embodiments, the link crawl depth may be determined based on a breadth-first search algorithm, a depth-first search algorithm, or the like. As used herein, a depth-first search (DFS) may refer to an algorithm starts at a root node (e.g., selecting an arbitrary first linked URL in a web page as the root node) and explores as far as possible along each branch node (e.g., a second linked URL included in the first linked URL) before backtracking. A breadth-first search (BFS) may refer to an algorithm starts at a root node (e.g., selecting an arbitrary linked URL in a web page as the root node), and explores all of the neighbor nodes (e.g., other linked URLs in the web page) at the present depth prior to moving on to the nodes at the next depth level. In some embodiments, the link crawl depth may be set manually by a user, or determined by one or more components of the cloud computing system 100 according to default settings. For example, the user may set the link crawl depth in the crawling job, and the link crawl depth may be stored in the corresponding configuration file, and accordingly, the server 110 (e.g., the first link generation logic module 41102) may extract the one or more linked URLs based on the link crawl depth and/or according to the configuration information associated with the task.

In some embodiments, the server 110 may extract the linked URL(s) offline, Merely by way of example, the server 110 (e.g., the crawler module 4108) may store the at least one web page in a file system (e.g., an HDFS) after the web page is fetched. In some embodiments, the server 110 (e.g., the crawler module 4108) may determine one or more feature values corresponding to element information of the at least one web page. In some embodiments, the server 110 (e.g., the crawler module 4108) may store the one or more feature values corresponding to the element information in one or more distributed storage nodes of the distributed file system. The server 110 (e.g., the second link generation logic module 41104) may obtain one or more web pages from the file system offline and periodically. The server 110 (e.g., the second link generation logic module 41104) may extract one or more linked URLs from the at least one web page. In some embodiments, the server 110 (e.g., the second link generation logic module 41104) may determine the link crawl depth based on the one or more feature values corresponding to the element information. In some embodiments, the server 110 (e.g., the second link generation logic module 41104) may extract the one or more linked URLs from the at least one web page based on the link crawl depth and/or according to the configuration information associated with the task. For example, the user may set the link crawl depth in the crawling job, and the link crawl depth may be stored in the corresponding configuration file, and accordingly, the server 110 (e.g., the first link generation logic module 41102) may extract the one or more linked URLs based on the link crawl depth and/or according to the configuration information associated with the task.

In 820, the server 110 (e.g., the link discover module 4110) may store the one or more extracted linked URLs in a seed database (e.g., the seed database 4104).

The server 110 may store the one or more extracted linked URLs in the seed database synchronously or asynchronously. For example, the server 110 may push the one or more extracted linked URLs into a message queue. The server 110 may pop one or more linked URLs from the message queue. The server 110 may store the one or more popped linked URLs in the seed database (e.g., the seed database 4104).

It should be noted that the above description is merely provided for the purpose of illustration, and not intended to limit the scope of the present disclosure. For persons having ordinary skills in the art, multiple variations and modifications may be made under the teachings of the present disclosure. However, those variations and modifications do not depart from the scope of the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in a combination of one or more programming languages, including an object oriented programming language such as Java, Scala, Smalltalk, Eiffel, JADE, Emerald, C++, C #, VB. NET, Python or the like, conventional procedural programming languages, such as the “C” programming language, Visual Basic, Fortran 2103, Perl, COBOL 2102, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, for example, an installation on an existing server or mobile device.

Similarly, it should be appreciated that in the foregoing description of embodiments of the present disclosure, various features are sometimes grouped in a single embodiment, figure, or description thereof for the purpose of streamlining the disclosure aiding in the understanding of one or more of the various inventive embodiments. This method of disclosure, however, is not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

1. A system for cloud computing, comprising:
an application program interface (API) configured to provide a user interface to obtain a crawling job submitted by a user;
a seed database, in communication with the API, configured to store one or more uniform resource locators (URLs) associated with the crawling job; and
a job generator, in communication with the seed database, configured to obtain the one or more URLs and to dispatch each of the one or more URLs to a corresponding crawler module,
wherein the crawler module, in communication with the job generator, is configured to fetch at least one of website data or webpage data based on the one or more URLs.

2. The system of claim 1, wherein the crawler module comprises at least one of a spider crawler module or a chrome crawler module, and the chrome crawler module is configured to perform a JavaScript rendering operation on at least one of a rendered web page or a user-defined page prior to fetching the webpage data.

3. The system of claim 1, further comprising:
a link discover module, in communication with the crawler module and the seed database, configured to:
determine a link crawl depth of the crawling job by parsing at least one of the website data or the webpage data fetched by the crawler module;
update the crawling job based on the link crawl depth; and
feed back the updated crawling job to the seed database.

4. The system of claim 3, wherein the link discover module comprises a first link generation logic module configured to:
determine the link crawl depth of the crawling job by parsing, in real time, at least one of a first copy file of the website data or a second copy file of the webpage data fetched by the crawler module;
update the crawling job based on the link crawl depth; and
feed back the updated crawling job to the seed database in real time.

5. The system of claim 4, further comprising:
one or more distributed storage nodes, in communication with the one or more crawler modules, configured to
distributedly store element information associated with at least one of the fetched website data or the fetched webpage data according to a preset list.

6. The system of claim 5, wherein the link discover module further comprises:
a second link generation logic module, in communication with the one or more distributed storage nodes, configured to:
determine, offline according to a predetermined schedule, one or more feature values corresponding to the element information stored in the one or more distributed storage nodes;
determine the link crawl depth based on the one or more feature values corresponding to the element information;
update the crawling job based on the link crawl depth; and
feed back the updated crawling job to the seed database.

7. The system of claim 6, wherein the one or more feature values comprise at least one of a frame parameter, an identification parameter, a label parameter, a type parameter, a text parameter, or an index parameter.

8. The system of claim 7, further comprising:
a parsing module, in communication with the one or more distributed storage nodes, configured to:
convert the element information into a specified format using one or more preset parsing algorithms; and
store the element information in the specified format in the one or more distributed storage nodes.

9. The system of claim 8, wherein the parsing module is in communication with the API, and the API is further configured to obtain one or more parsing algorithms submitted by the user, and wherein the one or more submitted parsing algorithms are designated as the one or more preset parsing algorithms stored in the parsing module.

10. The system of claim 2, further comprising:
a proxy module, in communication with the crawler module, configured to:
collect and verify one or more proxies with hypertext transfer protocols (HTTPs); and
cooperate with the crawler module to fetch at least one of website data or webpage data based on the one or more URLs.

11. The system of claim 10, wherein the proxy module is further configured to provide a crawling pressure control for the chrome crawler module.

12. The system of claim 11, wherein at least one of the one or more URLs that the chrome crawler module supports for crawling comprises a user-defined logic algorithm.

13. The system of claim 1, further comprising:
a crawling pressure control module, in communication with the crawler module, configured to control, according to at least one of a preset count of concurrent fetch requests or a preset crawling frequency, the crawler module to fetch at least one of the website data or webpage data.

14. The system of claim 1, wherein the system for cloud computing runs on an operation and maintenance platform on a basis of platform-as-a-service (PAAS).

15. The system of claim 14, wherein the operation and maintenance platform is configured to initiate a container for implementing the crawling job.

16. The system of claim 15, wherein the operation and maintenance platform is further configured to manage the container dynamically.

17. The system of claim 1, wherein the system for cloud computing is in communication with or includes a storage system configured to store a configuration file including configuration information relating to the crawling job.

18. A system for cloud computing, comprising:
at least one storage medium including a set of instructions; and
at least one processor in communication with the at least one storage medium, wherein when executing the set of instructions, the at least one processor is configured to cause the system to:
responsive to receive a request comprising one or more uniform resource locators (URLs), store the one or more URLs in a seed database;
select at least one URL from the seed database based on a first count of tasks waiting to be executed;
generate a task based on each of the at least one selected URL;
dispatch the task to a corresponding crawler module to cause the crawler module to fetch at least one web page according to an URL associated with the task;
extract element information of the at least one web page by parsing the at least one web page; and
store the element information in a file system

19. The system of claim 18, wherein the at least one processor is configured to cause the system to:
receive, via an application program interface (API), the request for web crawling initiated by a user.

20-33. (canceled)

34. A method implemented on a computing device having one or more processors and one or more storage devices for web crawling, the method comprising:
responsive to receiving a request comprising one or more uniform resource locators (URLs), storing the one or more URLs in a seed database;
selecting at least one URL from the seed database based on a first count of tasks waiting to be executed;
generating a task based on each of the at least one selected URL;
dispatching the task to a corresponding crawler module to cause the crawler module to fetch at least one web page according to an URL associated with the task;
extracting element information of the at least one web page by parsing the at least one web page; and
storing the element information in a file system.

35-50. (canceled)
